(19) United States
(12) Patent Application Publication
(10) Pub. No.: US 2009/0328034 A1
(43) Pub. Date: Dec. 31, 2009

(54) ESTABLISHING A BI-DIRECTIONAL GRID COMPUTING NETWORK

(75) Inventors: Sean D. Corcoran, Rochester, MN (US); Michael T. Kalmbach, Elgin, MN (US); Eric R. Larese, Rochester, MN (US); Jared W. Patterson, Rochester, MN (US); Kevin Wendzel, Rochester, MN (US)

Correspondence Address: CANTOR COLBURN LLP - IBM ROCHESTER DIVISION, 20 Church Street, 22nd Floor, Hartford, CT, 06103, US

(73) Assignee: International Business Machines Corporation, Armonk, NY (US)

(21) Appl. No.: 12/146,038

(22) Filed: Jun. 25, 2008

(51) Int. Cl. G06F 15/16; G06F 9/46

(52) U.S. Cl. 718/1; 709/201

(57) ABSTRACT

A method of establishing a bi-directional grid computing network includes submitting a processing job from a job requester to a central repository, querying nodes associated with the job requester to process the processing job, identifying suitable nodes associated with the job requester to process the processing job, transmitting the processing job from the job requester to at least one of the suitable nodes associated with the job requester, processing the processing job on the at least one suitable node associated with the job requester, and returning results from processing the processing job to the job requester.

### BACKGROUND OF THE INVENTION

1. Field of the Invention

Exemplary embodiments of the invention relate to the art of grid computing and, more particularly, to a method of establishing a bi-directional grid computing network.

2. Description of Background

In contrast, to a super computer that includes multiple processors connected by a high speed bus, grid computing is a form of parallel computing that relies on a plurality of discrete computers connected via a network. Grid computing offers a way to solve “Grand Challenge” such as, protein folding, financial modeling, earthquake simulation, climate/weather modeling, rendering complex graphics/animations, and the like.

At present, most grid computing networks are set up as one-way structures. That is, a sponsoring enterprise establishes a central processing center, develops specialty software for processing a particular problem, offer the software to potential participants in the grid and, once the potential participants download and run the software on a host computer and become actual participants, send data associated with the problem to the actual participants for processing. The data is processed on the host computer as a background application, such as part of a screen saver, or as a main application. Examples of such grid computing networks include SETI@home and Folding@home. The above examples illustrate a one-way grid computing structure, i.e., job requests are sent out from the sponsoring enterprise to participants, the participants cannot themselves send out a job request. Currently, at least one two-way grid computing structure, the Big and Ugly Rendering Project (BURP), allows participants to request grid processing. However, BURP is limited to a single application or processing type.

The Big and Ugly Rendering Project (BURP) uses a grid computing network for rendering graphics/animations. BURP is a non-commercial grid computing project using the Berkeley Open Infrastructure for Network Computing (BOINC) framework for volunteer computing originally developed to support the SETI@home project. BURP is currently under development to work as a publicly distributed system for the rendering of 3D graphics. BURP uses spare CPU cycles on participating computers to render 3D images and animations submitted by the users of the BURP. Thus, BURP allows individual users or subscribers to share computer resources solely for the purpose of rendering. Thus, BURP is limited to one type of processing. Moreover, the participants in BURP are not typically known to one another. Thus, there exists a possibility that some participants may hamper, alter, or hold up rendering projects submitted by other participants.

### SUMMARY OF THE INVENTION

The shortcomings of the prior art are overcome and additional advantages are provided through the provision of a method of establishing a bi-directional grid computing network in accordance with exemplary embodiments of the invention. The method includes submitting a processing job from a job requester to a central repository, querying nodes associated with the job requester to process the processing job, identifying suitable nodes associated with the job requester to process the processing job, transmitting the processing job from the job requester to at least one of the suitable nodes associated with the job requester, processing the processing job on the at least one suitable node associated with the job requester, and returning results from processing the processing job to the job requester.

System and computer program products corresponding to the above-summarized methods are also described and claimed herein.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution, which enables individual users to form a bi-directional grid computing network to process computing jobs. Moreover, the grid computing network links computers or nodes associated with a job requester, e.g. friends of the job requester, to provide a level of confidence when processing data. The grid computing network also enables a job requester to query and add friends of friends, to the job requestor's network to expand processing capabilities.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram of a grid computing network in accordance with exemplary embodiments of the invention;

FIG. 2 is a flow chart illustrating a method of establishing a grid computing network in accordance with exemplary embodiments of the invention; and

FIG. 3 is a schematic block diagram of a general-purpose computer suitable for practicing the present invention exemplary embodiments.

The detailed description explains the exemplary embodiments of the invention, together with advantages and features, by way of example with reference to the drawings.

### DETAILED DESCRIPTION OF THE INVENTION

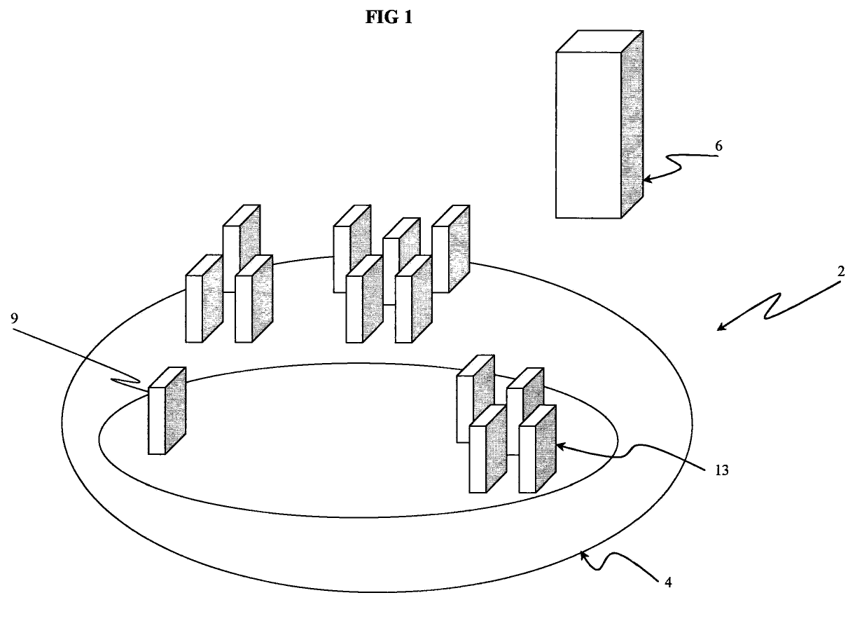

Turning now to the drawings in greater detail, it will be seen that in FIG. 1 there is a network indicated generally at 2. Network 2 includes a plurality of computers or nodes 4 operatively connected to a central repository 6. In accordance with exemplary embodiments of the invention, network 2 is configured as a bi-directional grid or distributed network that utilizes social networking concepts to share computer resources to process computer applications or jobs. As will be discussed more fully below, one of nodes 4 becomes a job requester 9 by submitting a processing job request to central repository 6. Central repository 6 queries others of nodes 4 in network 2 that are identified as “friends” 13 of job requester 9. More specifically, each individual or entity includes a corresponding identification or ID maintained within central repository 6 and recognized within the grid. Each ID is associated with one or more of the plurality of nodes 4. “Friendship” would exist between individuals or entities and not directly between nodes. In this way, when friendship between individuals or entities is established, access to any or all of the nodes belonging to each individual or entity is granted.

In any event, nodes identified as “friends” 13 that are available to process the job request are sent the job for processing. In accordance with one exemplary aspect of the invention, the job is sent directly from job requester 9. In accordance with another exemplary aspect of the invention, the job is passed to friends 13 via central repository 6. In any event, when complete, the processed job or results are passed back to the job requester, either directly or via central repository 6. By limiting processing jobs to nodes associated with the job requester, processing jobs are completed with any produced results having a high degree of confidence.

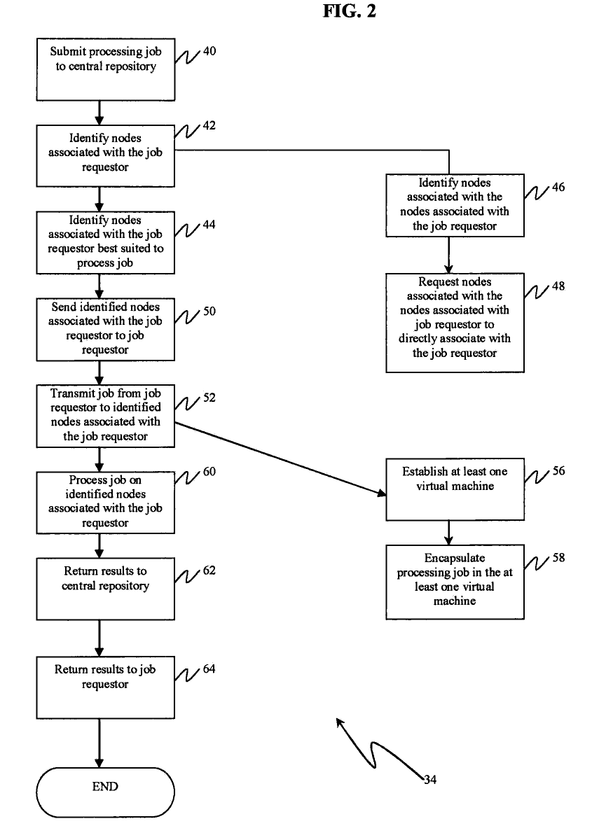

Reference will now be made to FIG. 2 in describing a method 34 of establishing a bi-directional grid computing network in accordance with exemplary embodiments of the invention. Initially, job requester 9 submits a processing job request to central repository 6 as indicated in block 40. Following the job request, central repository 6 identifies nodes 4 that are directly associated with job requester 9 as indicated in block 42. That is, job requester 9 possesses a database containing a list of nodes identified as “friends”. The database is either stored at job requester 9 or in central repository 6. Central repository 6 limits any requests from job requester 9 to nodes identified as “friends”. In order to expand the list of friends, job requester 9 can query nodes associated with nodes listed as friends of job requester 9 as indicated in block 46. Job requester 9 can then request that the nodes associated with nodes listed as friends of job requester 9, become friends themselves as indicated in block 48. That is, job requester 9 can ask “friends” of his/her “friends” to become “friends”.

Once all nodes directly associated with job requester 9 are identified, central repository 6 determines which of the identified associated nodes are best suited for processing the requested job as indicated in block 50. Central repository evaluates processor speed, memory size, as well as other factors such as, overall number of jobs currently being processed, types of jobs supported, and friend priority, to determine which of the identified associated nodes are suitable nodes, i.e., nodes best suited to process the requested job. Of course it should be understood that various other factors could be employed to determine a suitable node or nodes. Once the associated nodes best suited to process the requested job are identified, central repository 6 transmits the job to the associated suitable nodes as indicated in block 52. In accordance with one aspect of the exemplary embodiment, one or more virtual machines (VM) are established as indicated in block 56. In accordance with one aspect of the invention, the virtual machine(s) is established at central repository 6 or job requester 9 depending upon how jobs are being passed to friend nodes 13. At this point the job is encapsulated in the virtual machine as indicated in block 58. The virtual machine(s) including the job is then passed to each associated suitable node. In this manner, the job is processed without requiring that the associated suitable node include any special software or applications. At this point it should be understood that in accordance with one aspect of the exemplary embodiment, an entire job is encapsulated in a virtual machine and sent to every suitable friend node for processing, with the virtual machine including instructions for which portion of the job to execute. In accordance with another aspect of the invention, the job is broken down into constituent parts, each of which is then encapsulated in an associated virtual machine. Each virtual machine is then sent to a designated one of the suitable nodes (one virtual machine per node) for processing.

Once received, each of the associated suitable nodes processes the requested job, in whole or in part, as indicated in block 60, and returns any obtained results to central requester 6 as indicated in block 62. Central repository 6 in turn passes the results back to job requester 9 as indicated in block 64. Of course, it should be understood that job results may also be sent directly back to the requesting node, with nothing more than metadata, such as, but not limited to, job completion information, processing time for each node, information necessary to perform various checks to determine that all job parts are accurately completed, etc, associated with the requested job being passed on to the central repository. More specifically, while although in one exemplary embodiment, the entirety of the job results may be returned via the central repository, the job results may also be passed directly back to the requesting node. At this point it should be understood that exemplary embodiments of the present invention enable individual users to form a bi-directional grid computing network to process computing jobs. Moreover, the bi-directional grid computing network in accordance with exemplary embodiments of the invention, links computers or nodes associated with a job requester, e.g. friends of the job requester, to provide a level of confidence when processing data. The grid computing network also enables a job requester to query and add “friends of friends” to the job requestor's network to expand processing capabilities.

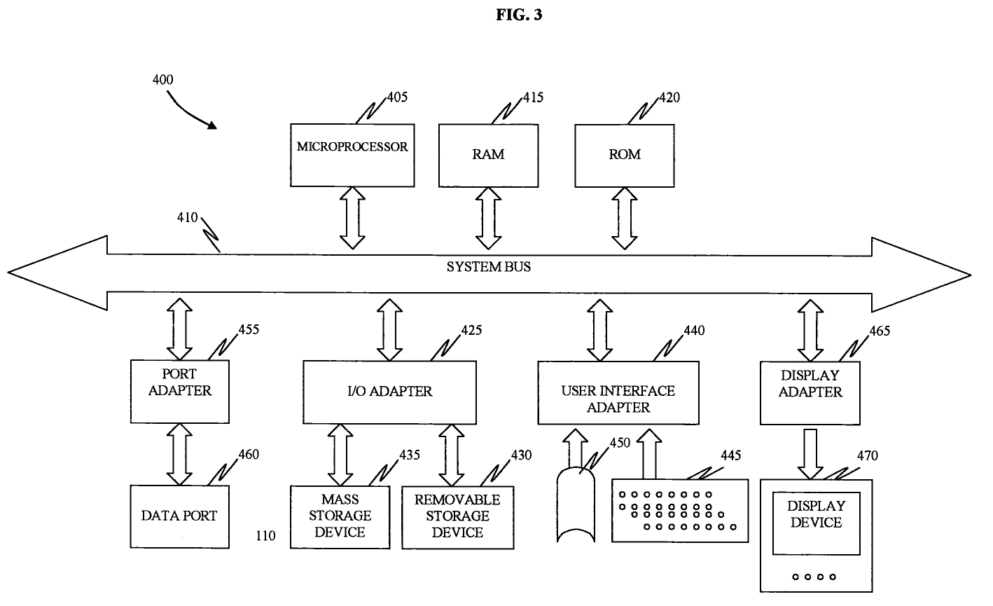

The capabilities of the present invention can be implemented in software, firmware, hardware or some combination thereof. As one example, the method of establishing a grid computing network described herein is practiced with a general-purpose computer and the method may be coded as a set of instructions on removable or hard media for use by the general-purpose computer. FIG. 3 is a schematic block diagram of a general-purpose computer suitable for practicing the present invention embodiments. In FIG. 3, computer system 400 has at least one microprocessor or central processing unit (CPU) 405. CPU 405 is interconnected via a system bus 410 to a random access memory (RAM) 415, a read-only memory (ROM) 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using keyboard 445.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of establishing a bi-directional grid computing network, the method comprising:
submitting a processing job from a job requestor to a central repository;
querying nodes associated with the job requestor to process the processing job;
identifying suitable nodes associated with the job requestor to process the processing job;
transmitting the processing job from the job requestor to at least one of the suitable nodes associated with the job requester;
processing the processing job on the at least one suitable node associated with the job requestor; and
returning results from processing the processing job to the job requester.

2. The method of claim 1, wherein querying nodes associated with the job requestor comprises querying nodes listed in a database associated with the job requester.

3. The method of claim 2, wherein querying nodes listed in a database associated with the job requestor comprises querying a friend database directly associated with the job requester on a social network.

4. The method of claim 1, further comprising:
identifying nodes associated with the nodes associated with the job requester; and
requesting the nodes associated with the nodes associated with the job requester to become directly associated with the job requester.

5. The method of claim 1, further comprising:
establishing at least one virtual machine;
encapsulating at least a portion of the processing job in the at least one virtual machine; and
transmitting the at least one virtual machine including the portion of the processing job to the at least one of the suitable nodes associated with the job requester for processing.

6. The method of claim 1, wherein returning results from processing the processing job to the job requester comprises passing the results to the job requester through the central repository.

7. A system for establishing a bi-directional grid computing network comprising:
a central processing unit (CPU), said CPU being interconnected functionally via a system bus to:
an input/output (I/O) adapter connecting to at least one of a removable data storage device, a program storage device, and a mass data storage device;
a user interface adapter connecting to one or more computer input devices;
a display adapter connecting to a display device; and
at least one memory device thereupon stored a set of instructions which, when executed by said CPU, causes said system to:
submit a processing job from a job requester to a central repository;
query nodes associated with the job requester to process the processing job;
identify suitable nodes associated with the job requester to process the processing job;
transmit the processing job from the job requester to at least one of the suitable nodes associated with the job requestor;
process the processing job on the at least one suitable node associated with the job requestor; and
return results from processing the processing job to the job requester.

8. The system of claim 7, wherein the set of instructions which, when executed by said CPU, causes said system to: query nodes listed in a database associated with the job requester.

9. The system of claim 8, wherein the set of instructions which, when executed by said CPU, causes said system to: query a friend database directly associated with the job requester on a social network.

10. The system of claim 7, wherein the set of instructions which, when executed by said CPU, causes said system to:
identify nodes associated with the nodes associated with the job requester; and
request the nodes associated with the nodes associated with the job requester to become directly associated with the job requester.

11. The system according to claim 7, wherein the set of instructions which, when executed by said CPU, causes said system to:
establish at least one virtual machine;
encapsulate at least a portion of the processing job in the at least one virtual machine; and
transmit the at least one virtual machine including the portion of the processing job to the at least one of the suitable nodes associated with the job requester for processing.

12. The system according to claim 7, wherein the set of instructions which, when executed by said CPU, causes said system to: return the results from processing the processing job to the job requester through the central repository.

13. A computer program product comprising:
a computer useable medium including a computer readable program, wherein the computer readable program when executed on a computer causes the computer to:
submit a processing job from a job requester to a central repository;
query nodes associated with the job requester to process the processing job;
identify suitable nodes associated with the job requester to process the processing job;
transmit the processing job from the job requester to at least one of the suitable nodes associated with the job requester;
process the processing job on the at least one suitable node associated with the job requester; and
return results from processing the processing job to the job requester.

14. The computer program product of claim 13, wherein the computer readable program when executed on a computer causes the computer to: query nodes listed in a database associated with the job requester.

15. The computer program product of claim 14, wherein the computer readable program when executed on a computer causes the computer to: query a friend database directly associated with the job requester on a social network.

16. The computer program product of claim 13, wherein the computer readable program when executed on a computer causes the computer to:
identify nodes associated with the nodes associated with the job requester; and
request the nodes associated with the nodes associated with the job requester to become directly associated with the job requester.

17. The computer program product of claim 13, wherein the computer readable program when executed on a computer causes the computer to:
establish at least one virtual machine;
encapsulate at least a portion of the processing job in the at least one virtual machine; and
transmit the at least one virtual machine including the portion of the processing job to the at least one of the suitable nodes associated with the job requester for processing.

18. The computer program product of claim 13, wherein the computer readable program when executed on a computer causes the computer to: return the results from processing the processing job to the job requester through the central repository.
